(19) United States
(12) Patent Application Publication
(10) Pub. No.: US 2016/0373799 A1
(43) Pub. Date: Dec. 22, 2016

(54) REMOTE MONITORING AND CONTROL OF MULTIPLE IPTV CLIENT DEVICES

(71) Applicant: Telefonaktiebolaget LM Ericsson (publ), Stockholm (SE)

(72) Inventors: Paul SCOVANNER, San Carlos, CA (US); Nguyen TRAN, Milpitas, CA (US); Max MELOCHE, Sunnyvale, CA (US); Aparna VARANASI, San Jose, CA (US); Ann CHAPMAN, Santa Cruz, CA (US)

(21) Appl. No.: 15/096,542

(22) Filed: Apr. 12, 2016

Related U.S. Application Data
(60) Provisional application No. 62/180,538, filed on Jun. 16, 2015.

(51) Int. Cl. H04N 21/4227; H04N 21/431; H04N 21/41; H04N 21/61; H04N 21/643

(52) U.S. Cl. CPC H04N 21/4227; H04N 21/6125; H04N 21/64322; H04N 21/4108; H04N 21/4122; H04N 21/4312

(57) ABSTRACT

A method in an electronic device, of enabling remote control of a plurality of Internet Protocol Television (IPTV) client devices is disclosed. The method includes receiving an identification of each of the plurality of IPTV client devices, where the identification includes an IP address associated with the IPTV client device. The method continues with receiving at least one input from a user, which corresponds to one or more control commands to be performed by a subset of IPTV client devices at substantially the same time. The method further includes transmitting a copy of the one or more control commands within a set of IP packets to each one of the subset of IPTV client devices, where each set of IP packets is destined to one IPTV client device based on the IP Address of the IPTV client device.

### CROSS-REFERENCE TO RELATED APPLICATIONS

This application claims the benefit of U.S. Provisional Application No. 62/180,538, filed Jun. 16, 2015, which is hereby incorporated by reference.

### FIELD

Embodiments of the invention relate to the field of Internet Protocol Television (IPTV); and more specifically, to systems and methods of remote monitoring and control of IPTV client devices.

### BACKGROUND

IPTV is a multimedia delivery platform that utilizes a packet-based network infrastructure (e.g., broadband Internet access networks) to deliver video content to customers, typically as an alternative to delivery by traditional over-the-air television, satellite television, and cable television. A typical IPTV solution includes head-end video acquisition equipment for receiving television content, intermediate IPTV facilities (e.g., Ericsson Mediaroom™) including server platforms and associated IPTV middleware, networking devices (e.g., routers, switches) for content distribution between various nodes of the IPTV system, access nodes (e.g., very-high-bit-rate digital subscriber line (VDSL or VHDSL) or passive optical network (PON) equipment) to enable high-bandwidth transport to and from the customer premises, and operator-provided applications that manage the IPTV system and/or provide end-user IPTV applications.

Consumers (also referred to as users, end users, viewers, customers, or subscribers) of IPTV services utilize user interfaces of operator-provided applications on client devices (such as set-top boxes (STBs), tablets, smartphones, laptops, personal computers, etc.) to access IPTV content. However, the applications are often tremendously complex systems including many layered graphical interface objects and allowing various actions to be performed by the user of the client device through the use of an input interface (e.g., a remote control, a touch based input interface, voice based input interface etc.). Each service operator may provide multiple applications to run on different client devices to users of the service. The various application-client device combinations are tested during the lifecycle of each product to ensure the reliability of the applications and the client devices.

### SUMMARY

A method in an electronic device, of enabling remote control of a plurality of Internet Protocol Television (IPTV) client devices is disclosed. The method includes receiving an identification of each of the plurality of IPTV client devices, where the identification includes an IP address associated with the IPTV client device. The method continues with receiving at least one input from a user, which corresponds to one or more control commands to be performed by a subset of IPTV client devices at substantially the same time. The method further includes transmitting a copy of the one or more control commands within a set of IP packets to each one of the subset of IPTV client devices, where each set of IP packets is destined to one IPTV client device based on the IP Address of the IPTV client device.

A method in an electronic device, of enabling remote control of a plurality of Internet Protocol Television (IPTV) client devices is disclosed. The method includes receiving an identification of each of the plurality of IPTV client devices, wherein the identification includes an IP address associated with the IPTV client device. The method continues with receiving at least one input from a user through a graphical user interface, where the at least one input corresponds to one or more control commands to be performed by a subset of IPTV client devices at substantially the same time, and the subset of IPTV client devices includes at least two IPTV client devices from the plurality of IPTV client devices. The method further continues with converting the at least one input into the one or more control commands, and transmitting a copy of the one or more control commands within a set of IP packets to each one of the subset of IPTV client devices, wherein each set of IP packets is destined to one IPTV client device based on the IP Address associated with the IPTV client device.

A non-transitory machine-readable storage medium that provides instructions is disclosed. The instructions, if executed by a processor, will cause said processor to perform operations comprising receiving an identification of each of a plurality of IPTV client devices, wherein the identification includes an IP address associated with the IPTV client device. The operations further include receiving at least one input from a user through a graphical user interface, where the at least one input corresponds to one or more control commands to be performed by a subset of IPTV client devices at substantially the same time, and the subset of IPTV client devices includes at least two IPTV client devices from the plurality of IPTV client devices. The operations further include converting the at least one input into the one or more control commands, and transmitting a copy of the one or more control commands within a set of IP packets to each one of the subset of IPTV client devices, where each set of IP packets is destined to one IPTV client device based on the IP Address associated with the IPTV client device.

### BRIEF DESCRIPTION OF THE DRAWINGS

The invention may best be understood by referring to the following description and accompanying drawings that are used to illustrate embodiments of the invention. In the drawings:

FIG. 1 illustrates a block diagram of an IPTV testing system for enabling control and monitoring of IPTV client devices and applications according to some embodiments of the invention.

FIG. 2 is a flow diagram illustrating operations for enabling control and monitoring of multiple IPTV client devices according to some embodiments of the invention.

FIG. 3 illustrates a flow diagram for enabling side-by-side remote monitoring of multiple IPTV client devices.

FIG. 4 illustrates an exemplary graphical user interface of the remote controller for enabling a user to remotely control and monitor multiple IPTV client devices.

FIG. 5 illustrates a detailed view of a graphical user interface for remotely monitoring the output of an IPTV client device.

FIG. 6 illustrates an exemplary graphical user interface of displaying a history of control commands executed by and IPTV client device.

FIG. 7 illustrates a block diagram for an exemplary electronic system including a remote controller for enabling remote control and monitoring of multiple IPTV client devices according to some embodiments of the invention.

### DESCRIPTION OF EMBODIMENTS

The following description describes methods and apparatus for remote control and monitoring of multiple Internet Protocol Television (IPTV) client devices. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The complexity of the IPTV systems and the variety of the systems deployed to consumers of IPTV services would greatly benefit from a side-by-side testing and monitoring system. For example it is desirable to compare various IPTV applications provided by different service providers while running on the same client device. Alternatively, it may be desirable to test the same application running on different version of clients or to compare different hardware configurations when running the same version of the client device. It may also be desirable to compare side-by-side an updated version of an application with an earlier version of the same application following the update and/or compare the same application running against different network topologies. Thus, testing of various client devices is performed to ensure that the user's experience is not negatively impacted by any changes or updates that may have occurred in one of the components of the IPTV system. These changes may be due to application updates, or client device updates or any other update in the system (e.g., updates to the head-end video acquisition equipment, to the intermediate IPTV facilities, to the client device, to the applications running on the client device etc.). Further, it is also desired, by operators, to provide custom application user interfaces (UIs) for different users or devices, and it has proven tremendously difficult to maintain such custom UIs. Side-by-side testing enables discrimination testing, allowing a trained tester to quickly detect minor defects of the systems.

In traditional approaches monitoring and testing of multiple client devices (such as set-top-boxes) of IPTV systems is performed entirely manually by a trained tester while the tester is physically in front of the IPTV client devices. In these traditional approaches a trained tester sets up multiple client devices in a laboratory facility (e.g., in the case of set-top-boxes, each STB is connected to a display device and to a content source) and manually sends control commands to each of the devices (e.g., the commands are sent to each client device with a remote control coupled to the device). The control of the multiple devices requires line of sight and direct control of each one of the devices. In a typical testing scenario, the same sequence of predefined commands is executed on each client device. In order to test the multiple devices, the tester monitors the result of the same command on the display connected to each client device. This task is time consuming and prone to errors. For example, if the tester performs an error while dialing a command on the remote control of a first device, the entire sequence of commands may have to be repeated for all the devices. In a typical testing environment tens to hundreds of devices may need to be tested simultaneously. In such environment and in a traditional approach, the tester manually sends a command to each of the client devices which can be very time consuming In addition since the tester uses remote control (generally an Infra-Red remote), the signal may miss the targeted client device or get directed toward another device (which was not targeted). Further the tester may not be able to send commands at substantially the same time and consequently evaluate accurately the response time of each device. In addition it may be desirable to test multiple client devices at substantially the same time in order to test and monitor the reliability of the system at a larger scale.

A method and system for controlling and monitoring multiple client devices of an IPTV system is presented herein. The embodiments of the present invention present a system and method for enabling reliable remote control and monitoring of multiple client devices. The embodiments of the inventions enables a tester to control multiple client devices (e.g., set-top-boxes) from a remote location and receiving a real time audio/visual feedback that can be viewed side-by-side on the control device of the tester without having the need of being physically located at the same location as of the client devices. Further, the embodiments of the invention enable a tester to control multiple client devices (e.g., set-top-boxes) at the same time, by selecting a list of client devices to be tested and providing an input indicating the control command to execute on all of the devices from the list. The tester is then provided in real time with an audio/visual feedback content in response to that command for all of the client devices from the list allowing them to monitor and potentially detect any defect that may occur.

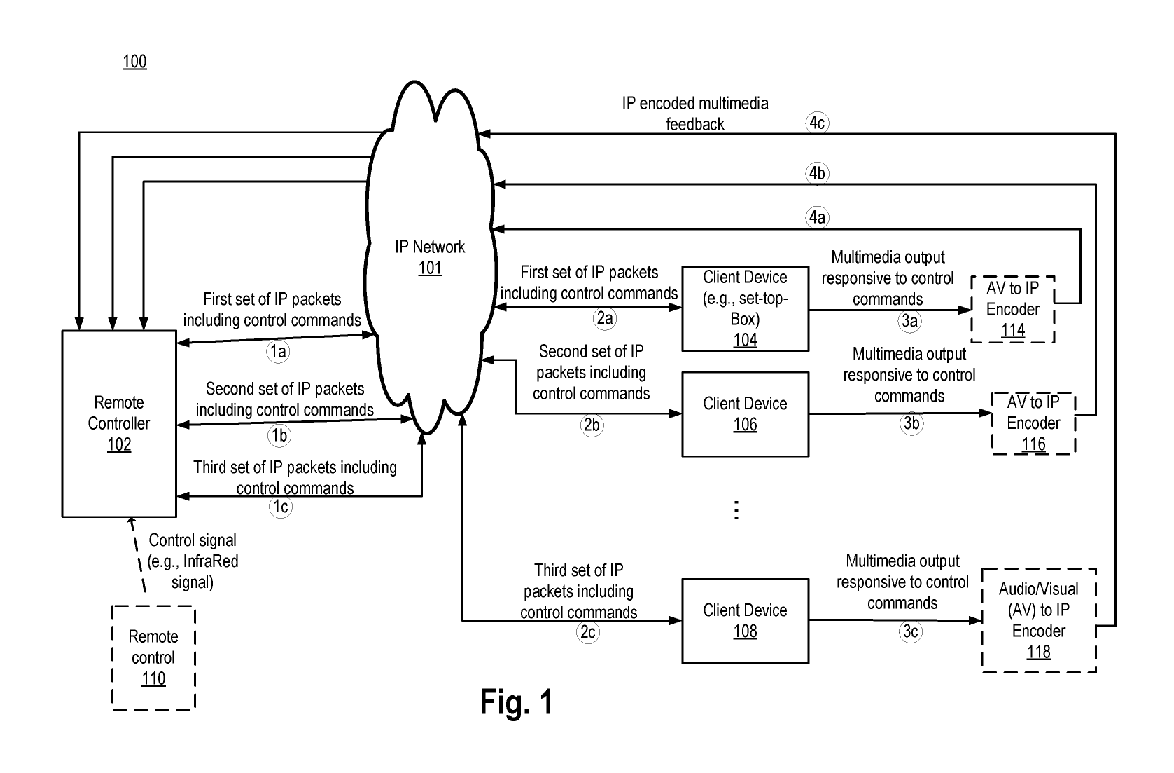

FIG. 1 illustrates a block diagram of an IPTV testing system for enabling control and monitoring of IPTV client devices and applications according to some embodiments of the invention. The IPTV system 100 includes a remote controller 102, coupled with multiple client devices (e.g., client device 104, client device 106, and client device 108) through the IP network 101. The IPTV system 101 further includes a set of audio/visual (AV) to IP encoders (e.g., AV to IP encoder 114, 116, and 118). In some embodiments, the IPTV system 100 may further include a remote control 110.

The client devices 104, 106, and 108 (or viewing systems, consumer devices, client devices, etc.) are electronic devices used by users to access audio/visual content via an IPTV system. A non-limiting example of a client device includes a Set-Top-Box (STB), which can be connected to a display (commonly a television, but can also be another type of monitor, projector, etc.). Other examples of client devices include smart phones, tablets, and laptops or desktop computer—each of which including a processor, computer-readable storage, a display, and an IPTV application that executes to allow connectivity/interaction with an IPTV system. However, other client devices can be implemented as anyone or combination of wired and/or wireless device, as any form of television client device (e.g., STB, digital video recorder (DVR)), gaming device, computer device, portable computer device, consumer device, media device, communication device, video processing and/or rendering device, appliance device, mobile phone (e.g., cellular, Voice over IP (VoIP), WiFi, etc.), a portable media device (e.g., a personal/portable media player, handheld media player, etc.), and/or as any other type of device that is implemented to receive media content in any form of audio, video, and/or image data. A client device (e.g., client 104) is associated with a device identification (e.g., a name and a list of parameters belonging to the device). Further each one of the client devices (104, 106, and 108) has an associated IP address allowing the device to communicate with other IP devices through IP networks such as the network 101.

The various client devices (104, 106, 108) shown in system 100 may or may not include a respective display device. A client device and display device together render and playback any form of audio, video, and/or image data (which will be referred to herein below as multimedia content). The client devices may output analog or digital content. The client devices described herein can also be implemented with any differing combinations of other components such as one or more processors, communication components (e.g., network interfaces), memory components, and/or processing and control circuits. For example, a client device may include network interfaces to receive multimedia data (audio/video, image data) from an IPTV system, a content provider and/or an IPTV testing system, and/or interfaces to receive broadcast and/or over-the-air inputs via which multimedia content can be received over the air. The client devices may also include one or more tuners to tune television channels and/or data streams for display and viewing.

The client devices 104, 106, and 108 are adapted to receive IP packets including multimedia content and process the content to be displayed on the display device (which is either part of the client device or external to the device). The client devices includes elements (hardware or software elements) for decrypting and decoding the multimedia content to be displayed. Further the client devices are adapted to receive IP packets including control commands. In some embodiments, the control commands are received separately from the multimedia content. The control commands are executed by each client device to perform a variety of action. A non-exhaustive list of exemplary of control commands is presented herein below : Rewind, Fast Forward, Stop, Pause, Play, Skip, Backward, Skip Forward, Record, Guide, Video On Demand (VOD), Digital Video Recorder (DVR), Menu, Up, Down, Left, Right, Info, Select, Exit, Back, Clear, Enter, Options, Power Off, Power, Power On, Alternate Audio, Aspect Ratio, Search, Slower, Faster, Quit, Play/Pause, Delete, Next, Help, Favorites, Teletext, Closed Captions, System Information, Volume Up, Volume Down, Mute, Channel Up, Channel Down, Last, 1, 2, 3, 4, 5, 6, 7, 8, 9, 0. The commands may further include a set of custom commands that may be configured by the user of the client device. In some embodiments the control commands may be any command that may be included in a traditional remote control used for enabling selection of inputs to the client device.

In some embodiments, the client devices are located at the same location within the same testing facility. For example, the client devices may be in the same room of a testing laboratory or in different rooms of a testing laboratory. In other embodiments, each of the client devices is located in a different location remote from the other client devices. In some embodiments, the client devices may be identical while in other embodiments, at least some of the client devices are different from one another. In some of these embodiments, the client devices may have identical hardware components but may differ in terms of software applications being executed on the hardware components. For example, the devices may run different versions of operator-provided application (e.g., TV Guide Applications). While FIG. 1 illustrates three client devices only 104, 106, and 108, one would understand that more devices may be included in the system 100. In some embodiments tens to hundreds of client devices may be remotely coupled to the remote controller 102 to be controlled and/or monitored.

The audio/visual to IP encoders 114, 116, and 118 are adapted to convert the multimedia content received from a respective client device 104, 106, or 108 into a set of IP packets to be transmitted through the network 101 to the remote controller 102. In some embodiments, the AV to IP encoder may be a hardware component externally coupled with the client device through a wired or wireless connection. In these embodiments the AV to IP encoder includes a processor and a memory including instructions causing the AV to IP encoder to compress the multimedia content (e.g., the compression may be performed according to any type of compression algorithm such as H.264, MPEG2, etc...). In alternative embodiments, the AV to IP encoders may be a software or a hardware element each being located within their respective client device (104, 106, or 108). For example, the client device 104 may be a tablet, and may comprise a software or a chipset AV to IP encoder within the tablet. In another example, the client device 104 is an STB coupled through a wired connection to the AV to IP encoder 114.

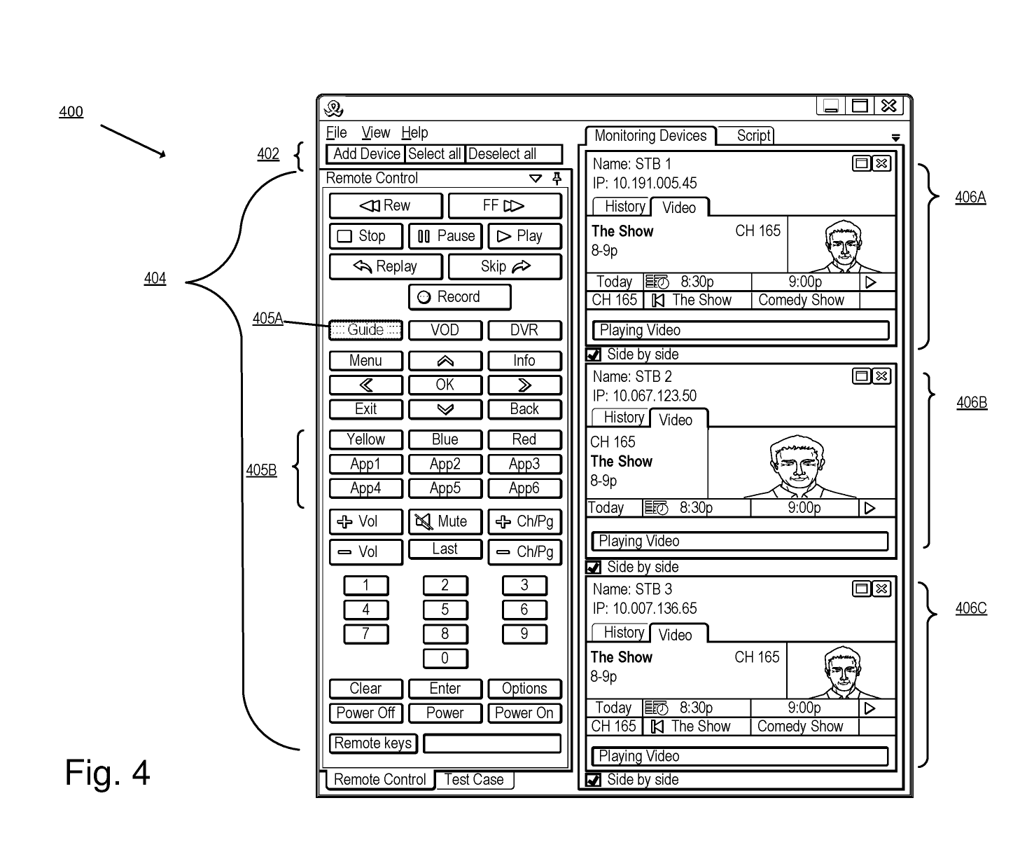

The remote controller 102 enables a user to control and monitor multiple IPTV client devices (e.g., client device 104, client device 106, and 108). In some embodiments, the remote controller 102 enables a user (e.g., a trained tester) to select multiple client devices to be monitored and controlled. In some embodiments the remote controller 102 enables a user to input one or more control command to be executed on each of the multiple client devices 104, 106, and 108 simultaneously (i.e., at substantially the same time). In some embodiments, the remote controller 102 may enable a user to further select a subset from the set of client devices to be controlled and monitored. The remote controller is coupled with each of the client devices through the network 101. The remote controller is located remotely from each of the client devices. The remote controller 102 will be described in further details with respect to the block diagrams of FIGS. 4, 5, 6, and 7, and the operations of the flow diagrams 2, and 3.

In some embodiments, the system 100 may additionally include a remote control 110 associated with the remote controller 102. The remote control 110 may be used to send control commands to the client device(s) (104, 106, and 108) via the remote controller 102. For example, the remote control 110 may be a remote control of a set-top-box client device, or a gaming controller for entering user-selectable inputs to a gaming client device. The remote control 110 can be a handheld Infra-Red device that sends digitally-coded pulses of infrared radiation to the remote controller 102, in order to control functions such as power, volume, television channel, or other features of the client devices 104, 106, and 108.

In FIG. 1, the circled numbers are used to denote each communication between the different devices in the system. In some embodiments, the order of operations follows the order of the circled numbers. In other embodiments, the order of operations is different from the order illustrated in the circled numbers.

At circles 1a, 1b, and 1c, the remote controller 102 transmits a set of IP packets to each of the client devices 104, 106, and 108 through the IP network 101. Each set of IP packets transports a set of one or more control commands to be executed by a respective client device. At circles 2a, 2b, and 2c each of the client devices 104, 106, and 108 receives the respective set of IP packets including the control commands The client devices are adapted to perform operations in response to the control commands and output multimedia content (audiovisual data) in response to the control commands In some embodiments each of the client devices is coupled with a source of audio visual data which is independent of the commands received from the remote controller 102. The commands cause the client devices to alter the multimedia data displayed through the client device or to perform another type of actions (record, increase the volume, etc.). In a non-limiting example, the client devices (104, 106, and 108) are set-top-boxes receiving television content from a content service provider. Upon receipt of a control command from the remote controller 102, the STB may open a TV guide of the service provider for viewing details about the TV program. In another example, the control command may be a command for recording some of the content received at each set-top-box. In a further example, the control command may be a command for changing channels at each set-top-box. The client device forwards the multimedia content to the AV to IP encoder at circles 3a, 3b, and 3c. In some embodiments, the multimedia content forwarded is responsive to the control command that is performed in each client device. For example, the multimedia content may include a video stream with closed captioning displayed following the receipt of a closed captioning control command from the remote controller 102. The multimedia content is then encoded and transported (at circles 4a, 4b, and 4c) via the IP network back to the remote controller 102. The remote controller 102 receives the AV content feedback and is adapted to display the content received from each one the client devices on a display. In some embodiments the AV content is displayed side-by-side on a display device to enable a tester to monitor and evaluate the result of each control command forwarded remotely to the client devices in real time.

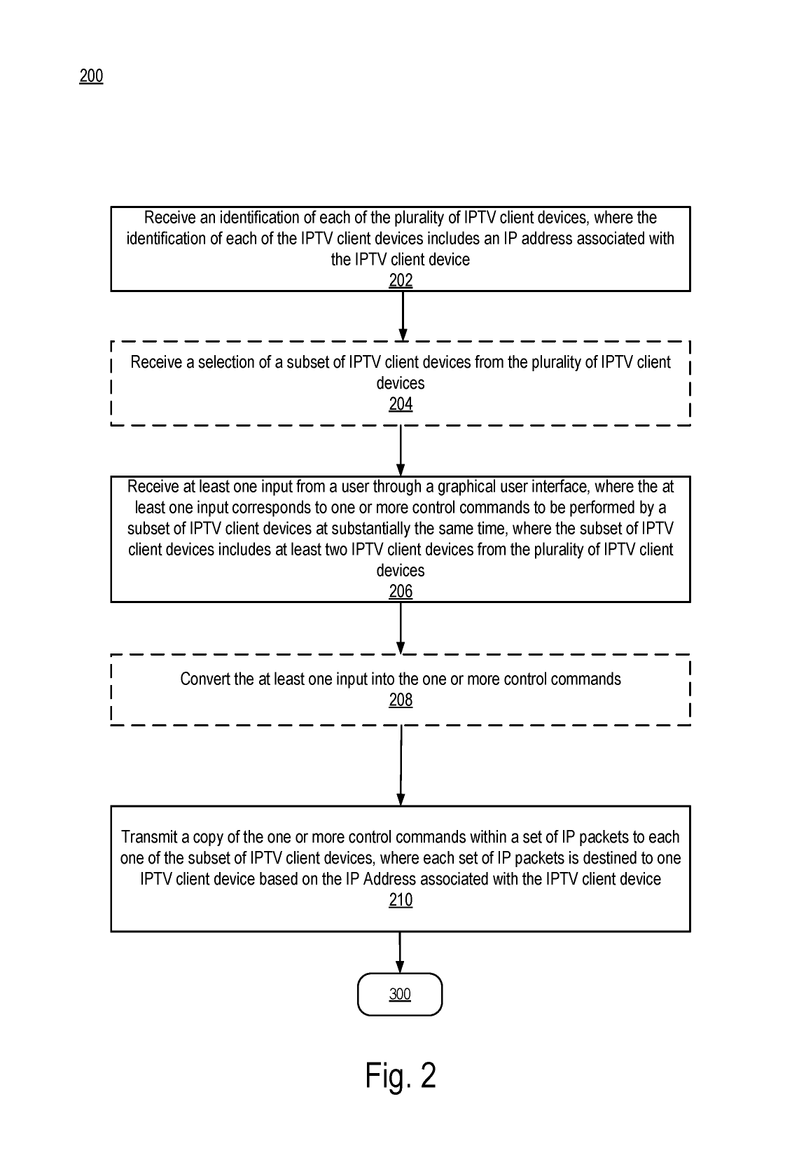

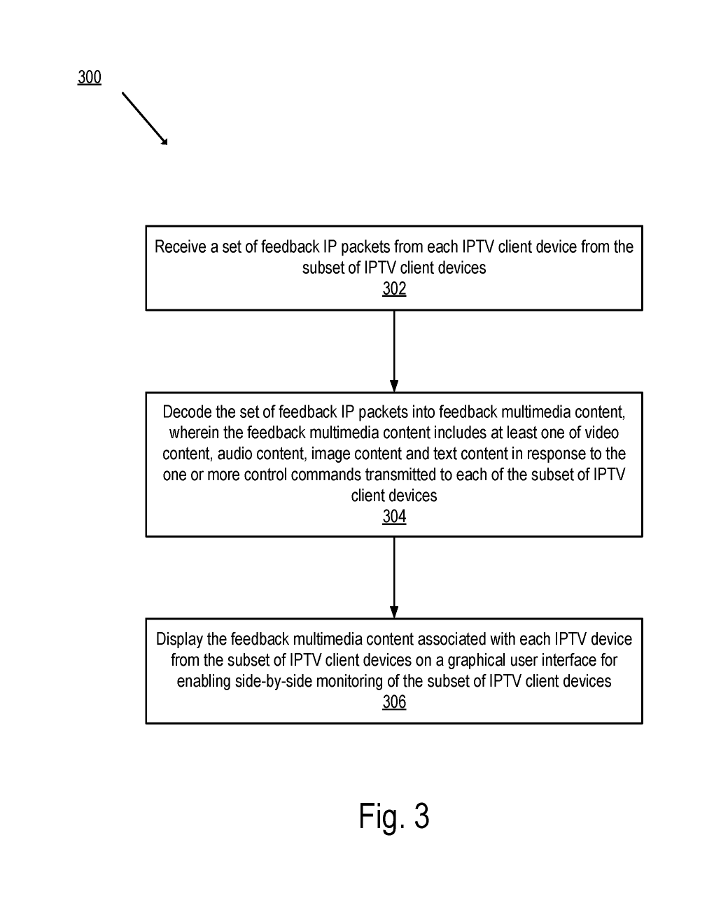

The operations in the flow diagrams of FIGS. 2 and 3 will be described with reference to the exemplary embodiments of FIGS. 1, 4, 5, and 6. However, it should be understood that the operations of the flow diagrams can be performed by embodiments of the invention other than those discussed with reference to the FIGS. 1, 4, 5, and 6, and the embodiments of the invention discussed with reference to FIGS. 1, 4, 5, and 6 can perform operations different than those discussed with reference to the flow diagrams of FIGS. 2 and 3.

FIG. 2 is a flow diagram illustrating operations for enabling control and monitoring of multiple IPTV client devices according to some embodiments of the invention. In some embodiments, the operations of the flow diagram are performed by the remote controller 102 of FIG. 1.

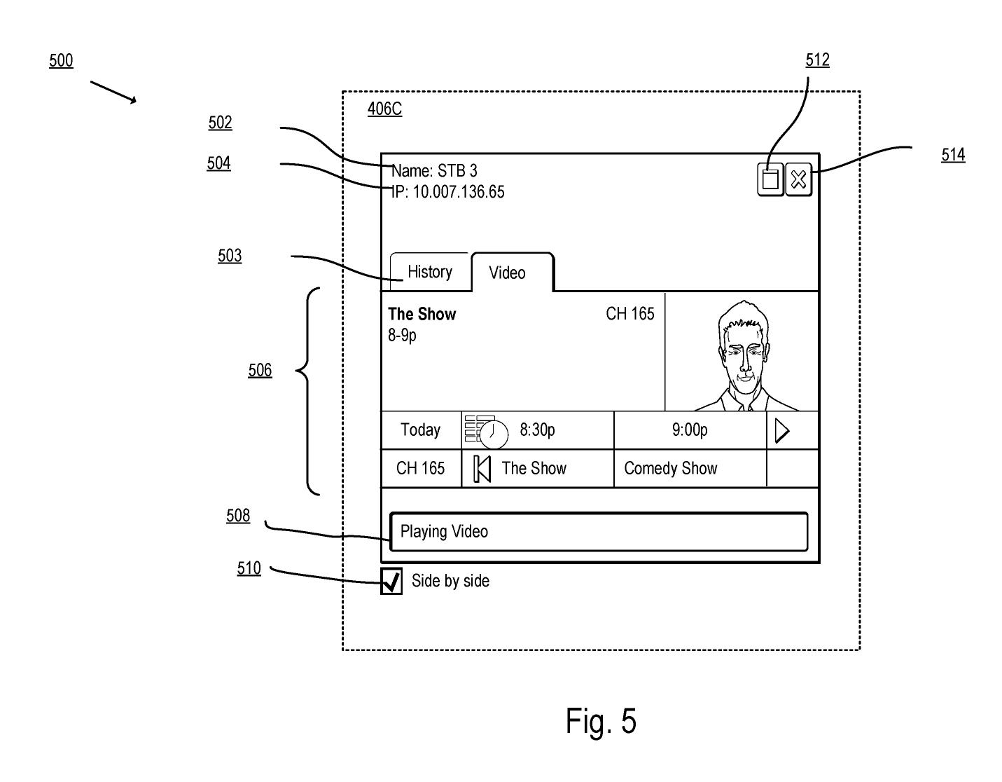

At block 202, the remote controller 102 receives an identification of each of the plurality of IPTV client devices, where the identification of each of the IPTV client devices includes an IP address associated with the IPTV client device. The identification of each device may include a name and/or identification number provided to each device, and an IP address assigned to the IPTV client device. In some embodiments the identification may further include the location of the device or any other information related to the IPTV client device. FIG. 5 illustrates a detailed view of a graphical user interface for remotely monitoring the output of an IPTV client device. In FIG. 5, element 502 provides a non-limiting example of a name of an IPTV client device being remotely controlled and monitored. Further element 504 represents the IP address of the IPTV client device 108. The remote controller 102 receives the identification of the IPTV client devices (e.g., IPTV client device 104, 106, and 108) through a graphical user interface (e.g., 400) allowing a user (e.g., tester) to add devices to the system to be monitored and controlled.

FIG. 4 illustrates an exemplary graphical user interface of the remote controller for enabling a user to remotely control and monitor multiple IPTV client devices. In some embodiments, a user may use the graphical user interface 400 to enter the identification of each IPTV client device to be monitored and/or remotely controlled. In the illustrated embodiments the element “Add Device” from the groups of graphical elements 402 allows a user to add a new IPTV client device to the testing system. For example, IPTV client device 104, may be added by entering a name and the IP address of the device. In non-limiting example, the name of the IPTV client device 104 may be STB 1 and its corresponding IP address is “IP: 10.191.305.45” as illustrated in FIG. 4 within the graphical element 406A. The identification of the IPTV client device may be received by the remote controller 102 at an initial set up time, when the user is initializing the system to monitor. The identification of the IPTV client device may be received at a later stage when a new IPTV client device is added to the system.

In some embodiments, the remote controller 102 stores a list of all IPTV client devices being monitored in a configuration file (e.g., XML file). This file is updated with the identification (including the IP address) of a new IPTV client device when the IPTV device is added by a user to be monitored and remotely controlled.

Although FIG. 4 illustrates an exemplary graphical element “Add Device” located within the group of elements 402 for adding a new device, the embodiments of the invention are not so limited. The graphical element may be located at another location within the graphical interface of the remote controller and have a different shape, size for adding a new device. In exemplary embodiments, new devices may be added by directly updating a configuration file, by selecting a device from a drop down menu etc.

Referring back to FIG. 2, at block 204, the remote controller 102 receives a selection of a subset of IPTV client devices from multiple IPTV client devices. The remote controller 102 is set up by a user to remotely control and monitor multiple IPTV client devices (e.g., the devices 104, 106, and 108 are set up at block 202). In some embodiments, the user selects a subset of these devices to initiate their remote control and/or monitoring. In some embodiments, the user may use the graphical user interface 400 of FIG. 4 to select the subset of the IPTV client devices to which a control command is to be sent. For example, the user may use the graphical element “select all” or “deselect all” to select or cancel a selection of the IPTV client devices. The subset of IPTV client devices may include the entire set of IPTV client devices configured to be monitored by the remote controller. In other embodiments, the subset is less than the entire set of IPTV client devices. In some embodiments the graphical element 510 or FIG. 5 may be used to select or deselect an IPTV device (e.g., IPTV client device 108 with the name STB 3 and IP address “10.007.136.65”). In the illustrated embodiment of FIG. 4, the three IPTV client devices (104 (i.e., STB 1); 106 (i.e., STB 2); and 108 (i.e., STB 3)) are selected to be monitored or receive a control command to be input by the user.

In some embodiments, the user may select a first subset of IPTV client devices to receive a first control command or set of commands (e.g., one of the control commands from the group 404 “Guide”-which will display the TV Guide as illustrated in the video section of each one of 406A, 406B, and 406C) and further select a second subset of IPTV client devices (not illustrated) to receive a different control command or set of commands (e.g., “Skip” command)

Referring back to FIG. 2, at block 206, the remote controller 102 receives an input from the user through the graphical user interface 400. The input corresponds to one or more control commands to be performed by a subset of IPTV client devices at substantially the same time. The subset of IPTV client devices includes at least two IPTV client devices from the set of IPTV client devices configured to be monitored by the remote controller 102.

In one exemplary embodiment, the user may select a graphical element from the group of graphical elements 404 to send a control command to the IPTV client devices to be executed at the same time by the selected IPTV client devices. The group of graphical elements may include elements for enabling the user to perform the following control command: “Rewind, Fast Forward, Stop, Pause, Play, Skip, Backward, Skip Forward, Record, Guide, Video On Demand (VOD), Digital Video Recorder (DVR), Menu, Up, Down, Left, Right, Info, Select, Exit, Back, Clear, Enter, Options, Power Off, Power, Power On, Alternate Audio, Aspect Ratio, Search, Slower, Faster, Quit, Play/Pause, Delete, Next, Help, Favorites, Teletext, Closed Captions, System Information, Volume Up, Volume Down, Mute, Channel Up, Channel Down, Last, 1, 2, 3, 4, 5, 6, 7, 8, 9, 0.” The graphical elements may further allow a user to program and perform custom control commands For example, in the illustrated embodiment of FIG. 400, elements 405B (e.g., “Yellow”, “Blue”, “Red”, “App1”, “App2”, “App3”, “App4”, “App5”, “App6”) may be configured by a user to perform custom control commands (e.g., launching a custom application; triggering a hidden feature; creating a shortcut to a commonly used feature which would otherwise require multiple commands etc.).

In an alternative embodiment, the user may use a remote control (e.g., remote control 110) coupled with the remote controller 102 to enter an input selecting a control command to be performed by the IPTV client devices remotely controlled by the remote controller 102. The remote controller 102 is adapted to receive a control signal (e.g., Infra-Red signal, Bluetooth Low Energy (BLE) signal, etc.) input from the remote control 110 corresponding to a control command to be performed simultaneously (i.e., at substantially the same time) on the IPTV client devices (e.g., set-top-boxes).

In another embodiments, the user may input a list of control command (e.g., input a script) to be sent to the multiple client devices. In an exemplary embodiment, the user may use the graphical user interface 400 to select a sequence of input keys (a sequence of graphical elements from the group 404), which is recorded (i.e., captured) by the remote controller 102. The remote controller 102 is then adapted to replay the recorded sequence to cause the IPTV client devices to execute the same control commands In alternative embodiments, the user may input a file comprising a list of control commands to be executed by the IPTV client devices. The list includes control commands in a format corresponding to a companion API and are already in a format executable by the IPTV client devices.

Referring back to FIG. 2, at block 208, the remote controller 102 converts the input received through the graphical user interface into one or more control commands to be performed by the IPTV client devices (e.g., STBs 104, 106, and 108). In some embodiments, the IPTV client devices (e.g., STBs) include a companion API system used to communicate and control the IPTV client devices. In these embodiments, upon receipt of an input through the graphical user interface 400, the remote controller 102 converts the input key into one or more control commands corresponding to control commands from the companion API. These control commands are executable by the IPTV client devices 104, 106, and 108.

In alternative embodiments, the remote controller 102 may receive the control commands in the proper format (e.g., a list of control command corresponding to control commands of the companion API) and the operation performed at block 208 is skipped as the control commands are already in a format executable by the IPTV client devices.

Referring back to FIG. 2, at block 210, the remote controller 102 transmits a copy of the control commands within a set of IP packets to each one of the selected IPTV client devices. As discussed above, the user may select all the IPTV client devices to receive the same set of control commands or alternatively they may select a subset of the remotely controlled IPTV client devices. According to the selection, the remote controller transmits a copy of the control commands to these devices within sets of IP packets. The selected subset of IPTV client devices includes two or more client devices (typically the set includes tens to hundreds of IPTV client devices (e.g., STBs)). The control commands are sent to the IPTV client devices based on their corresponding IP address. The remote controller 102 uses IP networks (e.g., network 101) to send the control command(s) via HTTP to each IPTV client devices (e.g., STB) asynchronously. Each IPTV client device (e.g., STB) then returns a confirmation that the control command(s) was received.

In the exemplary embodiment illustrated at FIG. 4, a user uses the graphical user interface of the remote controller 102 to select the IPTV client devices (e.g., 104 (STB 1), 106(STB 2), and 108(STB3)) to remotely control and monitor. The user further uses the graphical user interface 400 of the remote controller 102 to select and input the “GUIDE” input key (405A). The input key is converted by the remote controller 102 into a control command to be executed by the three IPTV client devices (104, 106, and 108). The control command is transmitted at substantially the same time by the remote controller 102 to each one of the client devices within IP packets through the IP network 101 to be executed by the IPTV client devices, causing the IPTV client to display the TV GUIDE (as shown in each of the windows 406A, 406B, and 406C).

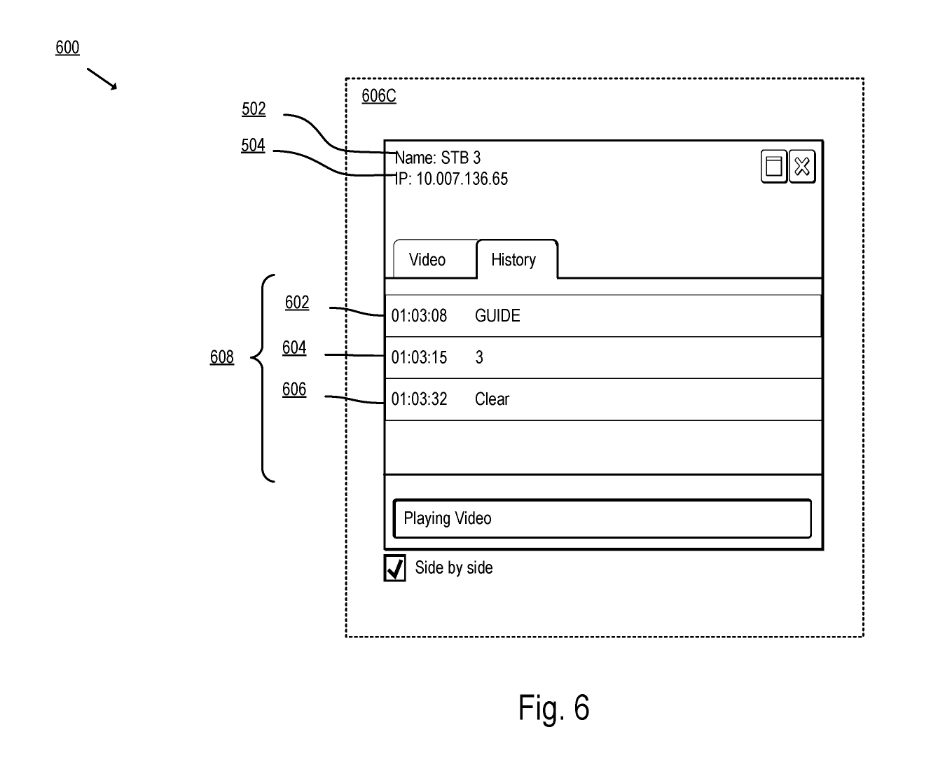

In some embodiments, the remote controller 102 records for each IPTV client device the history of control commands that is transmitted to the IPTV client devices. The history of control commands may be recorded to be played back at a later moment in time and executed by the same IPTV client devices (e.g., the IPTV client devices having been updated or configured with different settings) and/or to be executed by different IPTV client devices. The history of the control commands may be displayed on the graphical user interface of the remote controller 102 to enable the user to view the different control commands executed on each device. This enables the user to compare the different control command sequences performed on each device. FIG. 6 illustrates an exemplary graphical user interface of a window 606C showing a history of control commands executed by client device 108 (i.e., STB 3). 602, 604, and 606 are examples of control command that are executed on client device 108 (as identified by its name 502 (STB 3) and IP address 504 (“IP:10.007.136.65”). The history 608 may show a timestamp at which the control command was input and transmitted to be executed by the IPTV client device as well as the control command (e.g., 602 shows a time a timestamp “01:03:08” at which the control command “GUIDE” was input). The illustrated embodiment is exemplary only. The embodiments of the invention are not limited to the illustrated graphical representation of the history of control commands For example, the history of control commands may be stored in a separate file, which can be retrieved by the user to be viewed via a different graphical interface.

In one embodiment, the operations described with respect to the flow diagram of FIG. 2, and the block diagrams of FIGS. 4, 5 and 6 enable the remote control of multiple IPTV client devices. In these embodiments, the remote controller 102 enables a user to select multiple IPTV client devices (e.g., multiple set-top-boxes) and to select a control command to be simultaneously sent to the IPTV client devices. Contrary to prior approaches, the user does not need to be present at the location of the IPTV client devices. Further the control signal is reliably received to each one of the IPTV client devices. In some embodiments, the flow moves from block 210 to block 300. FIG. 3 illustrates a flow diagram 300 for enabling side-by-side remote monitoring of multiple IPTV client devices. Following the transmission of the control commands, the remote controller 102, at block 302 receives a set of feedback IP packets from each IPTV client device from the subset of IPTV client devices. At block 304, the remote controller 102 decodes the set of feedback IP packets into feedback multimedia content for each one of the IPTV client devices. The feedback multimedia content may include video content, audio content, image content and/or text content which is created at least in part in response to the one or more control commands transmitted to the IPTV client devices. At block 306, the remote controller 102 displays the feedback multimedia media content for each set of the feedback IP packets on a graphical user interface for enabling side-by-side monitoring of the subset of IPTV client devices.

In FIG. 4, windows 406A, 406B, and 406C are examples of a graphical user interface displaying the feedback multimedia content of each one of the IPTV client devices. In this embodiments, the feedback content is responsive to the selection of the “GUIDE” key resulting in a transmission of a guide control command to each of the devices 104, 106, and 108. The windows 406A, 406B, and 406C are selected to be displayed side-by-side (as illustrated in further detail at FIG. 5, graphical element 510 for the window 406C) to enable monitoring and comparison of the feedback content between the different IPTV client devices. In some embodiments, the IPTV client devices are identical devices in which one of the devices includes an updated (upgrade) of a software application. In the illustrated embodiment, window 406B displays a graphical user interface different from the one displayed in window 406A, and 406C. The display of all the feedback contents received from the different IPTV client devices side-by-side allows a user to better monitor and detect defects or differences between the various IPTV client devices tested. FIG. 5 illustrated a detailed view of the window 406C displaying feedback multimedia content received from the IPTV client device 108. The graphical element 506 includes the multimedia content output by the IPTV client device (e.g., a Set-To-Box). The element 508 include information regarding the type of content being displayed (e.g., Playing Video). Element 508 may include further details regarding the multimedia content (e.g., the information may include the encoding format (e.g., H.264, MPEG-2, etc . . . )). The window 406C may display additional information regarding the output of the IPTV client device which would allow the user to better monitor the IPTV devices. In the illustrated embodiment, the window 406C includes the identification of the IPTV client device (e.g., name 502, and IP address 50). The window 406C may include a tab 503 for displaying the history of control command executed on the IPTV client device (as is described in further details with reference to FIG. 6). The window 406C may further include element 512 (allowing a user to edit) and element 514 (allowing the user to close the window). In some embodiments, the windows 406A, and 406B include graphical element identical to the one described with respect to window 406C and FIG. 5.

While the illustrated embodiment of FIG. 4, show 3 windows associated with three IPTV client devices, the invention is not so limited. Additional IPTV client devices may be remotely controlled and monitored by the remote controller and the feedback content of each window may be displayed on the same graphical user interface. Further while the windows are shown to be vertically aligned (one on top of the other) in other embodiments, the windows may be vertically aligned. Further in some embodiments, the windows can be rearranged within the graphical user interface.

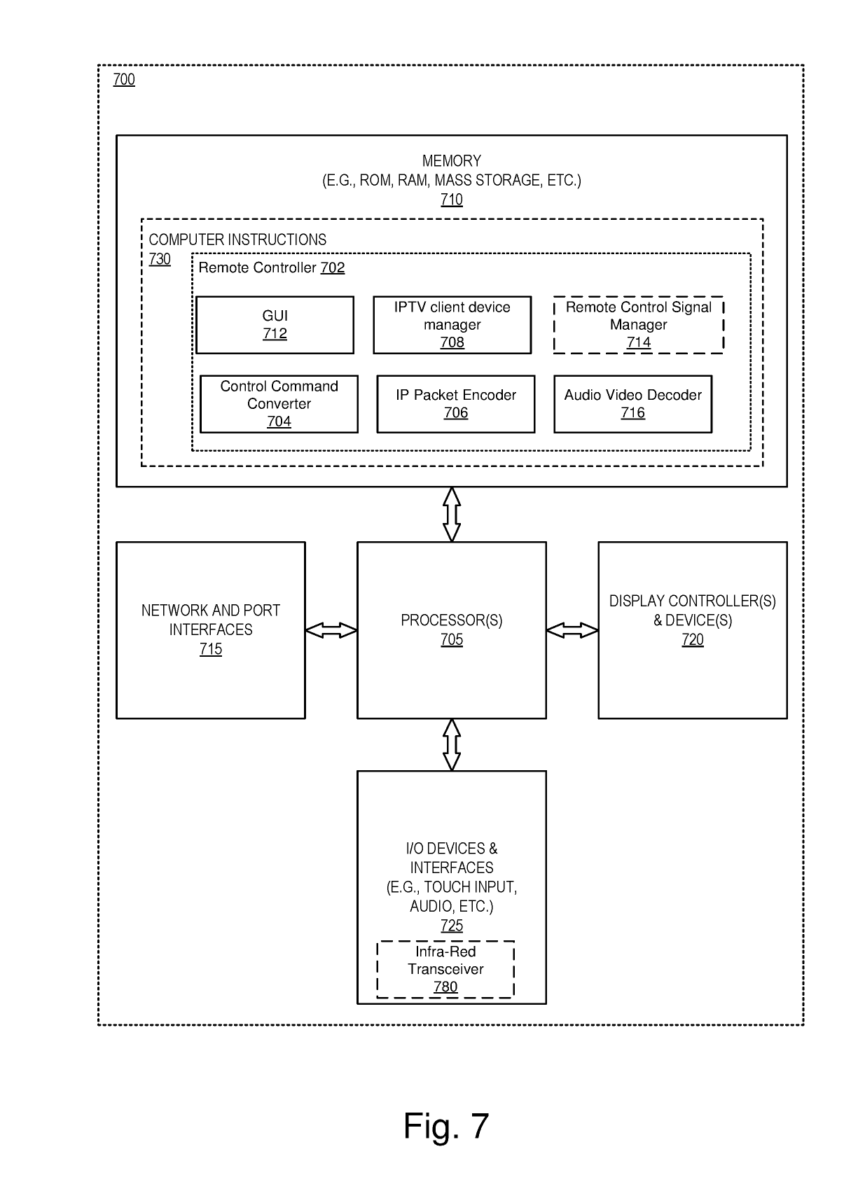

FIG. 7 illustrates a block diagram for an exemplary electronic system including a remote controller for enabling remote control and monitoring of multiple IPTV client devices according to some embodiments. In some embodiments, the remote controller 702 includes a graphical user interface (GUI) 707, an IPTV client device manager 708, a control command converter 704, an IP packet encoder 706, and an audio video decoder 716. In some embodiments the remote controller unit 702 may additionally include remote control signal manager 714. The remote controller 702 is operative to perform the operations of the embodiments described with respect to FIGS. 1-6. In some embodiments, the electronic system is one or more microprocessors 705 and connected system components (e.g., multiple connected chips). Alternatively, the electronic system 700 is a system on a chip.

In some embodiments, the IPTV client device manager 708 is operative to receive an identification of each of a plurality of IPTV client devices, which includes an IP address associated with the IPTV client device. The GUI 707 is operative to enable the remote controller 702 to receive at least one input from a user, wherein the at least one input corresponds to one or more control commands to be performed by a subset of IPTV client devices at substantially the same time, wherein the subset of IPTV client devices includes at least two IPTV client devices from the plurality of IPTV client devices. The control command converter is operative to convert the at least one input into the one or more control commands The IP packet encoder is operative to transmit a copy of the one or more control commands within a set of IP packets to each one of a subset of the plurality of IPTV client devices, where the subset includes two or more client devices, and where each set of IP packets is destined to one IPTV client device based on the IP Address of the IPTV client device. The audio/video decoder 716 is operative to decode a set of feedback IP packets into feedback multimedia content, where the feedback multimedia content is in response to the one or more control commands transmitted to each of the subset of IPTV client devices. The GUI 707 is further operative to display the feedback multimedia content.

An electronic system 700 includes a memory 710 and a processor 705. The memory 710 may be used for storing data, metadata, and programs for execution by the microprocessor(s) 705. For example, the depicted memory 710 may store computer instructions 730 that, when executed by the microprocessor(s) 705, causes the remote controller 102 of FIG. 1 to perform the operations described with reference to FIGS. 2-6. The memory 210 may include one or more of volatile and non-volatile memories, such as Random Access Memory (“RAM”), Read Only Memory (“ROM”), a solid state disk (“SSD”), Flash, Phase Change Memory (“PCM”), magnetic storage, or other types of data storage. The memory 710 may be internal or distributed memory. In some embodiments, a portion or all of the computer instructions 730 (including the remote controller unit 702) are stored on an external cloud device. In some embodiments, the graphical user interface 707 is displayed in a browser application, or alternatively on a desktop application.

The electronic system 700 may also include a display controller and display device 720 that provides a visual user interface for the user, e.g., GUI elements or windows. The display device 720 may also display various multimedia content to the user. The display device 720 may display a graphical user interface for remotely controlling and monitoring multiple IPTV client devices (e.g., the GUI 400, 500, and 600 of FIGS. 4, 5, and 6). The electronic system 700 also includes one or more input or output (“I/O”) devices and interfaces 725, which are provided to allow a user to provide input to, receive output from, and otherwise transfer data to and from the system. These I/O devices 725 may include a mouse, keypad, keyboard, a touch panel or a multi-touch input panel, camera, optical scanner, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the electronic system 700. The I/O devices and interfaces 725 may also include a connector for a dock or a connector for a USB interface, FireWire, Thunderbolt, Ethernet, etc., to connect the system 700 with another device, external component, or a network. Exemplary I/O devices and interfaces 725 also include wireless transceivers, such as an IEEE 1002.11 transceiver, an infrared transceiver (780), a Bluetooth transceiver, a wireless cellular telephony transceiver (e.g., 2G, 3G, 4G), or another wireless protocol to connect the remote controller 102 with another device, external component, or a network and receive stored instructions, data, tokens, and control commands from a remote control. In some embodiments, these various components will be provided as a system on a chip (SoC). It will be appreciated that one or more buses may be used to interconnect the various components shown in FIG. 7.

For example, the electronic system 700 may be a personal computer (PC), tablet-style device, a personal digital assistant (PDA), a cellular telephone (e.g., smartphone), a Wi-Fi based telephone, a handheld computer which may optionally include a cellular telephone, a media player, an entertainment system, a handheld gaming system, a wearable computing device (e.g., smartwatch, digital eyewear), or devices which combine aspects or functions of these devices, such as a media player combined with a PDA and a cellular telephone in one device. In other embodiments, the electronic device may be a network computer, server, network device, router, or an embedded processing device within another device or consumer electronic product. As used herein, the terms computer, system, device, processing device, and “apparatus comprising a processing device” may be used interchangeably with the term electronic system 700 and include the above-listed exemplary embodiments.

It will be appreciated that additional components, not shown, may also be part of the system 700, and, in some embodiments, fewer components than that shown in FIG. 7 may also be used in an electronic system 700.

It will be apparent from this description that aspects of the inventions may be embodied, at least in part, in software. That is, the computer-implemented methods may be carried out in a computer system or other data processing system in response to its processor or processing system executing sequences of instructions contained in a memory, such as memory 710 or other non-transitory machine-readable storage medium. The software may further be transmitted or received over a network (not shown) via a network and/or port interface 715. In various embodiments, hardwired circuitry may be used in combination with the software instructions to implement the present embodiments. Thus, the techniques are not limited to any specific combination of hardware circuitry and software, or to any particular source for the instructions executed by the electronic system 700.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method in an electronic device, of enabling remote control of a plurality of Internet Protocol Television (IPTV) client devices:
receiving an identification of each of the plurality of IPTV client devices, wherein the identification includes an IP address associated with the IPTV client device;
receiving at least one input from a user, wherein the at least one input corresponds to one or more control commands to be performed by a subset of IPTV client devices at substantially the same time, wherein the subset of IPTV client devices includes at least two IPTV client devices from the plurality of IPTV client devices; and
transmitting a copy of the one or more control commands within a set of IP packets to each one of the subset of IPTV client devices, wherein each set of IP packets is destined to one IPTV client device based on the IP Address of the IPTV client device.

2. The method of claim 1, further comprising:
converting the at least one input into the one or more control commands

3. The method of claim 2, further comprising:
receiving a set of feedback IP packets from each IPTV client device from the subset of IPTV client devices;
decoding the set of feedback IP packets into feedback multimedia content, wherein the feedback multimedia content includes at least one of video content, audio content, image content and text content in response to the one or more control commands transmitted to each of the subset of IPTV client devices; and
displaying the feedback multimedia content associated with each IPTV device from the subset of IPTV client devices on a graphical user interface for enabling side-by-side monitoring of the subset of IPTV client devices.

4. The method of claim 1, further comprising:
receiving a selection of the subset of IPTV client devices from the plurality of IPTV client devices, wherein the selection of the subset of IPTV client devices is performed through a graphical user interface.

5. A non-transitory machine-readable storage medium that provides instructions that, if executed by a processor, will cause said processor to perform operations comprising:
receiving an identification of each of a plurality of IPTV client devices, wherein the identification includes an IP address associated with the IPTV client device;
receiving at least one input from a user through a graphical user interface, wherein the at least one input corresponds to one or more control commands to be performed by a subset of IPTV client devices at substantially the same time, wherein the subset of IPTV client devices includes at least two IPTV client devices from the plurality of IPTV client devices; and
transmitting a copy of the one or more control commands within a set of IP packets to each one of the subset of IPTV client devices, wherein each set of IP packets is destined to one IPTV client device based on the IP Address associated with the IPTV client device.

6. The non-transitory machine-readable storage medium of claim 5, wherein the operations further include:
converting the at least one input into the one or more control commands

7. The non-transitory machine-readable storage medium of claim 6, wherein the operations further comprise:
receiving a set of feedback IP packets from each IPTV client device from the subset of IPTV client devices;
decoding the set of feedback IP packets into feedback multimedia content, wherein the feedback multimedia content includes at least one of video content, audio content, image content and text content in response to the one or more control commands transmitted to each of the subset of IPTV client devices; and
displaying the feedback multimedia content associated with each IPTV device from the subset of IPTV client devices on a graphical user interface for enabling side-by-side monitoring of the subset of IPTV client devices.

8. The non-transitory machine-readable storage medium of claim 5, wherein the operations further include receiving a selection of the subset of IPTV client devices from the plurality of IPTV client devices, wherein the selection of the subset of IPTV client devices is received through the graphical user interface.
